(19) United States
(12) Patent Application Publication
(10) Pub. No.: US 2002/0070929 A1
(43) Pub. Date: Jun. 13, 2002

(54) Emergency assistance device

(76) Inventor: W. C. Hunter, Ooltewah, TN (US)

Correspondence Address: John L. James, P. O. Box 2025, Marietta, GA, 30061-2025, US

(21) Appl. No.: 09/732,802

(22) Filed: Dec. 8, 2000

Related U.S. Application Data
(60) Provisional application No. 60/170,497, filed on Dec. 13, 1999.

(51) Int. Cl. G09G 5/00

(52) U.S. Cl. 345/204

(57) ABSTRACT

An emergency assistance device aids emergency personnel in locating an address where assistance is needed An emergency assistance device contains a housing. A lighting assembly mounted on a top panel of the housing provides a flashing or rotating light to visually attract the attention of emergency response personnel driving along the street. A display with a distress message is mounted on the front panel of the housing to alert anyone within eyesight that emergency assistance is desired. A siren provides an audible signal to alert attention. The housing can be mounted on a dwelling or may be mounted on a pole in the yard. When an emergency situation arises, the user activates the device with a remote control unit.

### CROSS-REFERENCE TO DISCLOSURE DOCUMENT

This application of the inventor is based on his Provisional Patent Application Serial No. 60/170,497, filed Dec. 11, 1999, entitled Electronic Address Identifier.

### FIELD OF THE INVENTION

The present invention relates generally to an identification device for identifying a person in need of assistance, and, more particularly, to a device for giving audio and visual signals and information.

### BACKGROUND OF THE INVENTION

Advanced technology and training have undoubtedly increased the number of lives saved when responding to emergency assistance calls. A person making an emergency (911) call from home automatically has the address appear on a computer screen. Even though the address is known, a response team often has difficulty locating the address in the filed. Valuable time can be lost searching for an address especially when it is dark or when addresses are clustered. It is desirable to have a device which alerts an emergency response team to the address requesting assistance.

### SUMMARY OF THE INVENTION

Briefly summarized, according to one aspect of the present invention, an emergency assistance device has a housing with a top panel, a bottom panel and a front panel attached to the top and bottom panels. A lighting assembly is mounted on the top panel, and a display is mounted on the front panel. A power supply in the housing supplies energy to the lighting assembly and the display. A mounting device mounts the housing at an elevation so that the display and lighting assembly are visible from a distance. Control circuitry controllably operates the lighting assembly and the display.

When activated from a remote control on or near the person requiring assistance, the device illuminates the lights which may flash or rotate to attract attention. A siren in the housing may sound to provide an audible signal. The display illuminates with a distress message alert anyone within view that emergency assistance is desired. The device provide visual and audible signal to alert emergency personnel of the dwelling where assistance is needed.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a diagrammatic exploded perspective view of a preferred embodiment of an emergency assistance device according to the present invention.

FIG. 2 is a diagrammatic exploded perspective view of another preferred embodiment of an emergency assistance device.

FIG. 3 is a front view of the mounting pole of FIG. 2.

FIG. 4 is a block diagram of the circuitry of the emergency assistance devices of FIGS. 1 and 2.

FIG. 5 is a perspective view of a transmitter for use with the emergency assistance devices of FIGS. 1 and 2.

FIG. 6 is a front view of a housing and lighting assembly according to the present invention.

### DETAILED DESCRIPTION OF THE PREFERRED EMBODIMENTS

Referring to FIG. 1, an emergency assistance device 10 has a housing 12 with a top panel 14, a bottom panel 16 and a front panel 18 attached to the top and bottom panels 14, 16. Mounting means, such as mounting bracket 20, are provided for mounting the housing 12 at an elevation so that a display 22 and lighting assembly 24 are visible from a distance. Mounting bracket 20 has vertical rails 26, 28 which may be attached to the front exterior wall of a dwelling, and has a horizontal shelf 30. The bottom panel 16 of the housing 12 rests on the shelf 30.

The lighting assembly 24 is mounted on the top panel 14. It preferably contains lights that flash or rotate like those of a police vehicle to be highly visible and attract the attention of an approaching emergency response team. A single rotating light 54 (FIG. 6) can be used.

The display 22 is mounted on the front panel 18 and flashes an emergency message, such as HELP for example. Flashing the emergency message causes the message to be highly visible and attract the attention of passersby as well as an approaching emergency response team. A passerby seeing the message could inquire within, summon emergency help, or wait to direct the emergency response team. Ideally, a passerby would make certain that emergency assistance has been summoned.

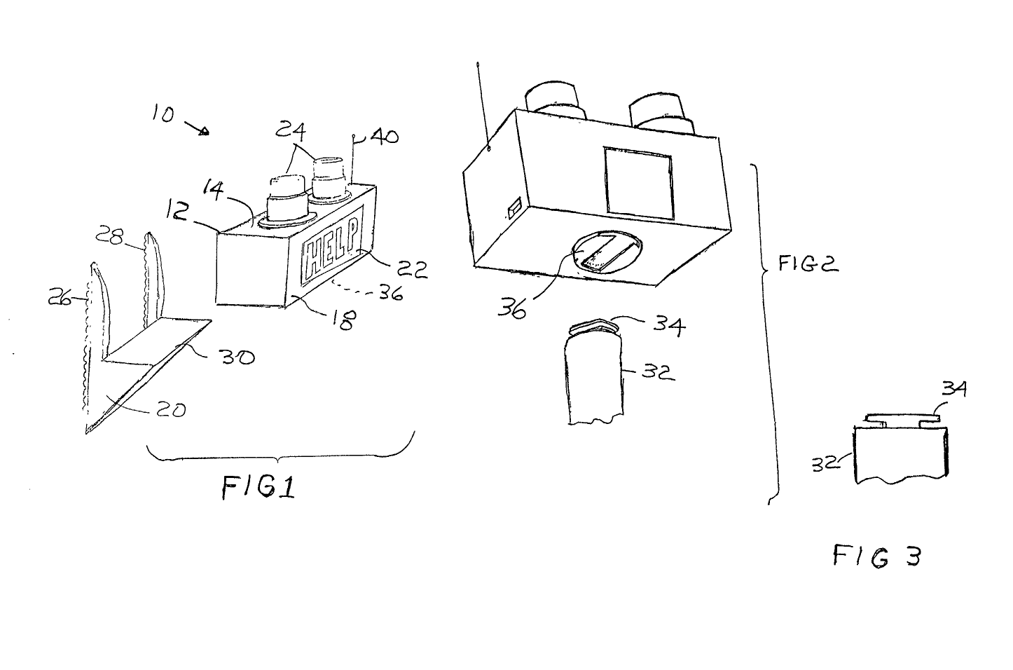

Referring to FIGS. 2-3, an alternate embodiment of the device is illustrated wherein the mounting means includes a mounting pole 32 for mounting the housing at an elevation so that the display and lighting assembly are visible from a distance. The top end of mounting pole 32 contains a key 34 that engages a keyway 36 on the bottom panel of the housing. The mounting pole allows the unit to be placed outside on a lawn where it is closer to the street for increased visibility.

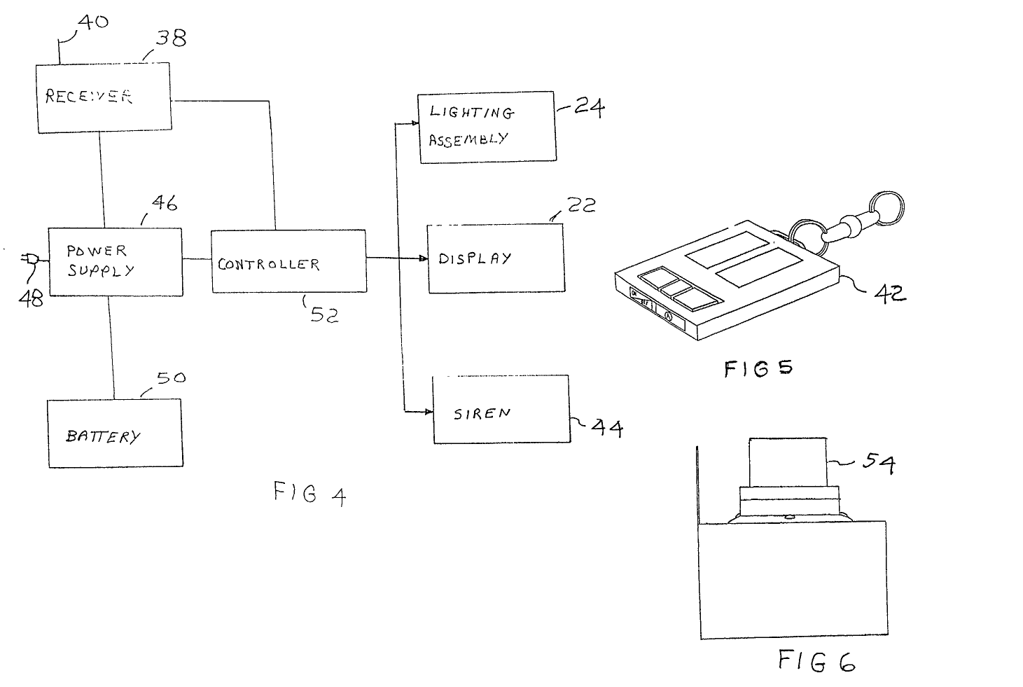

Referring to FIGS. 4-5, a receiver, such as a radio frequency receiver 38, has an antenna 40 that is physically mounted on the housing 12, preferably on the top panel 14. Antenna 40 receives signals from a transmitter 42. The signal sent by transmitter 42 is selected by depressing one of several push buttons. For example, a first push button would activate only the lighting assembly 24 while a second push button would only activate the display 22. A third push button could activate both the lighting assembly and the display simultaneously. A fourth push button could activate a siren 44.

The receiver is powered by a power supply 46 that can use house current via a power cord 48 or use battery power 50. The receiver and power supply are connected to a controller 52 for controllably operating the lighting assembly 24, display 22 and siren 44.

FIG. 6 illustrates another embodiment of the invention which uses a single.

Operation of the emergency assistance device is believed to be apparent from the foregoing description, but a few words will be added for emphasis. Where the device is to be wall mounted, the mounting bracket is first attached to the wall using nails, screws or other fasteners as appropriate. The housing is positioned on the shelf of the mounting bracket so that the lights and display are visible on an approach to the wall. Where the device is to be yard mounted, the mounting pole is first anchored in an upright position in the yard using a spike on the end of the pole or by anchoring the pole with dirt, tie wires, concrete or other material or method as appropriate for conditions. Next, the key on the top of the pole is inserted into the keyway on the bottom panel of the housing, and the housing is turned so that the lights and display are visible from the street or other approach to the building. Turning the housing also locks the housing to the pole. When an emergency arises requiring assistance, a person calls the 911 emergency number, then pushes a button on the transmitter to activate the lights and display, and perhaps the siren. When help arrives, the device is turned off by depressing an off button on the transmitter.

While the invention has been described with particular reference to the preferred embodiments, it will be understood by those skilled in the art that various changes may be made and equivalents may be substituted for elements of the preferred embodiments without departing from invention. Also, certain aspects of the invention are not limited to the particular details of the examples illustrated, and it is therefore contemplated that other modifications and applications will occur to those skilled in the art. It is accordingly intended that the claims shall cover all such modifications and applications as do not depart from the true spirit and scope of the invention.

What is claimed is:

1. An apparatus, comprising:
a housing having a top panel, a bottom panel and a front panel attached to said top and bottom panels;
a lighting assembly mounted on said top panel;
a display mounted on said front panel;
a power supply in said housing for supplying energy to said lighting assembly and said display;
means for mounting said housing at an elevation so that said display and lighting assembly are visible from a distance; and
means for controllably operating said lighting assembly and said display.

2. An apparatus, as set forth in claim 1, wherein said lighting assembly includes a flashing light.

3. An apparatus, as set forth in claim 1, wherein said lighting assembly includes a flashing light.

4. An apparatus, as set forth in claim 1, wherein said display controllably displays a distress message.

5. An apparatus, as set forth in claim 1, wherein said mounting means includes a bracket having a horizontal shelf, said bottom panel resting on said horizontal shelf.

6. An apparatus, as set forth in claim 1, wherein said mounting means includes a keyway on said bottom panel and a key atop a mounting pole.

7. An apparatus, as set forth in claim 1, including a siren in said housing, said siren being connected to and powered by said power supply.

8. An apparatus, as set forth in claim 1, wherein said activating means includes a receiver in said housing coupled to said power supply, display and lighting assembly. including:

9. An apparatus, as set forth in claim 1, wherein said activating means includes a receiver in said housing coupled to said power supply, display and lighting assembly.

10. An apparatus, as set forth in claim 9, including an antenna connected to said receiver and extending from said housing.

11. An apparatus, as set forth in claim 1, wherein said activating means includes a controller for controlling operation of said power supply, display and lighting assembly.
